(19) United States
(12) Patent Application Publication
(10) Pub. No.: US 2024/0414044 A1
(43) Pub. Date: Dec. 12, 2024

(54) RUNTIME FAULT INJECTION SYSTEM FOR CLOUD INFRASTRUCTURES

(71) Applicant: Microsoft Technology Licensing, LLC

(72) Inventors: Nidhi VERMA, Bellevue, WA (US); James John WALSH, Wicklow (IE); Oliver John CASTLE, Dublin (IE); Orla Patricia SHERIDAN, Westmeath (IE)

(73) Assignee: Microsoft Technology Licensing, LLC, (US)

(21) Appl. No.: 18/332,310

(22) Filed: Jun. 9, 2023

(51) Int. Cl. H04L 41/0604; H04L 41/0681

(52) U.S. Cl. CPC H04L 41/0618; H04L 41/0681

(57) ABSTRACT

A fault injection system for a cloud infrastructure utilizes fault injection agents instantiated on components of the cloud infrastructure to inject fault into the components. The faults are based on fault definitions which define the type(s) of fault(s) to inject, the scope for injecting the fault into the cloud infrastructure, deployment information for deploying the fault in the cloud, and remediation information which defines a plan for remediating the fault in the cloud infrastructure. The system monitors the impact of faults on the components which enables component dependencies to be determined.

### BACKGROUND

Cloud infrastructures provide computing resources, analytics, storage, and network resources to customers over a network, such as the Internet. These services may include, but are not limited to applications for creating, consuming, and/or modifying content, file storage and management platforms, collaboration and communications platforms, and other types of software as a service. A cloud infrastructure includes numerous servers, network devices, and storage elements to support the services provided. Servers can be implemented using physical as well as virtual machines. Cloud infrastructures also include numerous software components and services for performing various tasks in support of the services made available by the cloud infrastructures.

As the number of cloud infrastructure components increases, the deployment of hardware and software for cloud infrastructure and services becomes more complicated. Numerous faults and failures can occur, and are expected to occur, in cloud infrastructure components over time, such as server shutdowns, performance latency degradation, resource exhaustion, and the like. Due to the sheer number of components in a cloud infrastructure, it can be difficult to detect when components fail, identify which components have failed, and analyze the failure to determine the appropriate resolution. This problem is exacerbated by the fact that the performance of one component in a cloud infrastructure can be impacted directly or indirectly by the performance of many other components.

What is needed are systems and methods of evaluating cloud infrastructures that enable component faults and failures to be identified more effectively so the appropriate remediation actions may be taken.

### SUMMARY

In one general aspect, the instant disclosure presents a fault injection system having a processor and a memory in communication with the processor wherein the memory stores executable instructions that, when executed by the processor alone or in combination with other processors, cause the data processing system to perform multiple functions. The functions include receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components; instantiating fault injection agents in the targeted components based on the scope information and the deployment information, the fault injection agents being configured to cause the at least one fault type in the targeted components; monitoring a performance of the plurality of components while the fault injection agents are causing the at least one fault type in the targeted components to determine how the at least one fault type in the targeted components impacts the plurality of components; and determining dependencies of components in the cloud infrastructure on other components of the cloud infrastructure based on the monitored performance of the plurality of components.

In yet another general aspect, the instant disclosure presents a method for injecting fault into a cloud infrastructure. The method includes receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components; instantiating fault injection agents in the targeted components based on the scope information and the deployment information, the fault injection agents being configured to cause the at least one fault type in the targeted components; monitoring a performance of the plurality of components while the fault injection agents are causing the at least one fault type in the targeted components to determine how the at least one fault type in the targeted components impacts the plurality of components; and determining dependencies of components in the cloud infrastructure on other components of the cloud infrastructure based on the monitored performance of the plurality of components.

In a further general aspect, the instant application describes a non-transitory computer readable medium on which are stored instructions that when executed cause a programmable device to perform functions of receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components; instantiating fault injection agents in the targeted components based on the scope information and the deployment information, the fault injection agents being configured to cause the at least one fault type in the targeted components; monitoring a performance of the plurality of components while the fault injection agents are causing the at least one fault type in the targeted components to determine how the at least one fault type in the targeted components impacts the plurality of components; and determining dependencies of components in the cloud infrastructure on other components of the cloud infrastructure based on the monitored performance of the plurality of components.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIG. 2 depicts an example of a fault injection system for a cloud infrastructure, such as the cloud infrastructure of FIG. 1.

FIG. 3 depicts a diagram of a fault definition for defining faults to be injected into the cloud infrastructure by the fault injection system of FIG. 2.

FIG. 4 depicts a diagram of an example ring configuration for deploying faults in a cloud infrastructure, such as the cloud infrastructure of FIG. 1.

FIG. 5 depicts a flowchart of an example fault injection method for a cloud infrastructure.

FIG. 6 depicts a flowchart of another example fault injection method for a cloud infrastructure.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

Cloud infrastructures provide computing resources, analytics, storage, and network resources to customers over a network, such as the Internet. These services may include, but are not limited to applications for creating, consuming, and/or modifying content, file storage and management platforms, collaboration and communications platforms, and other types of software as a service. A cloud infrastructure includes numerous servers, network devices, and storage elements to support the services provided. Servers can be implemented using physical as well as virtual machines. Cloud infrastructures also include numerous software components and services for performing various tasks in support of the services made available by the cloud infrastructures.

As the number of cloud infrastructure components increases, the deployment of hardware and software for cloud infrastructure and services becomes more complicated. Numerous faults and failures can occur, and are expected to occur, in cloud infrastructure components over time, such as server shutdowns, performance latency degradation, resource exhaustion, and the like. Due to the sheer number of components in a cloud infrastructure, it can be difficult to detect when components fail, identify which components have failed, and analyze the failure to determine the appropriate resolution.

One method that has been used to identify faults in hardware and software systems involves injecting faults into select hardware and software components so that the impact of the fault can be observed and plans for addressing the fault can be made. Fault injection is effective in identifying fault impacts and component dependencies in hardware and software systems having a limited number of components. Previous fault injection techniques, however, are not effective in identifying the impact of faults and component dependencies in large-scale systems, such as cloud infrastructures, where the performance of one component can be impacted directly or indirectly by the performance of many other components in a cloud infrastructure.

To address these technical problems and more, in an example, this description provides technical solutions in the form of fault injection systems and methods that enable faults to be injected into components of a cloud infrastructure so that the fault's impact on the performance of the components can be observed which in turn enables component dependencies to be determined. The fault injection systems and methods involve the use fault injection agents which can be instantiated on targeted components to inject desired faults. A fault injection agent is instantiated based at least in part on a fault definition, which can be provided as an input to a fault injection system. The fault definition defines the type(s) of fault(s) to inject, the scope for injecting the fault into the cloud infrastructure, deployment information for deploying the fault in the cloud, and remediation information which defines a plan for remediating the fault in the cloud infrastructure.

The scope information and deployment information for a fault enables the full extent of the impact a fault in one component has on the performance of other components to be determined. For example, the scope information indicates the type and/or function of components to be targeted for the fault. The scope information can include selection criteria, such as usage, past incidents, risk levels, and services tiers, as well as customer type and geographic range, to be used to limit the targeted components so that dependencies can more easily be identified. Deployment information on the other hand enables various parameters for deploying faults to be defined, such as timing, deployment ring configuration, throttling procedure, and the like. Defining the timing, deployment ring configuration, and throttling procedures enables faults to be deployed in stages so that the impact of the fault on components and component dependencies can be more accurately observed and analyzed.

The impact on component performance is monitored while the fault is injected into the cloud infrastructure. In embodiments, the performance impact is used as the basis for determining when to expand deployment of a fault to the next ring level and/or throttling stage and to determine when to end the fault injection. The performance impact is also used as the basis for generating a dependency map for the cloud infrastructure. The dependency map identifies components and/or services that are impacted by the performance of other components and/or services. The performance information, including component dependencies, enables a more effective remediation plan to be generated which takes the full extent of the impact of a fault and component dependencies into consideration in determining a n optimum way to resolve such faults.

The technical solutions described herein address the technical problem of inefficiencies and difficulties in fault identification and remediation in cloud infrastructures. The technical effects at least include (1) enabling component faults in cloud infrastructures to be efficiently identified; (2) enabling component dependencies in cloud infrastructures to be identified and mapped which improves the ability to generate effective remediation plans to address faults in a cloud infrastructure; and (3) improving the efficiency of managing cloud infrastructure components.

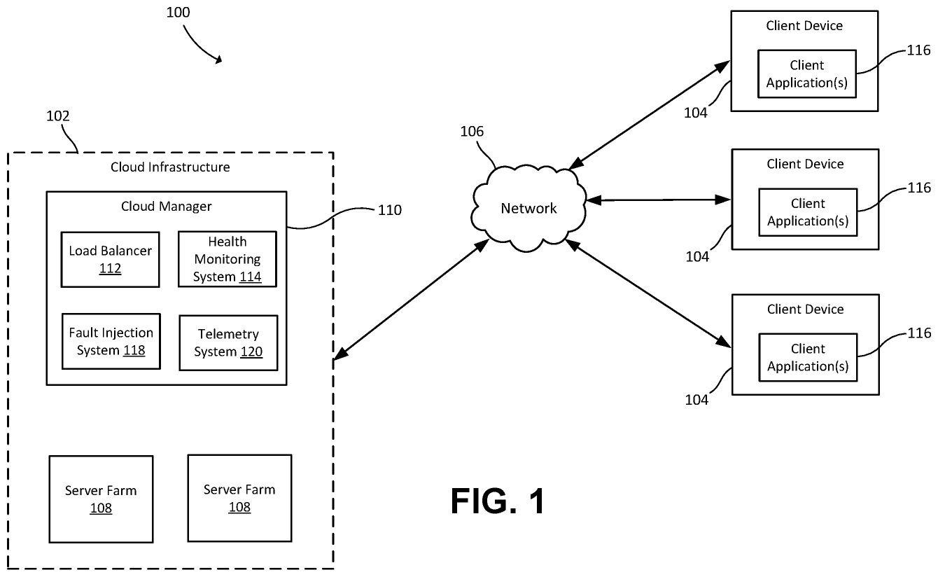

FIG. 1 is a diagram showing an example computing environment 100 in which aspects of the disclosure may be implemented. Computing environment 100 includes cloud infrastructure 102, client devices 104, and a network 106. The network 106 includes one or more wired and/or wireless networks. In embodiments, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate.

The cloud infrastructure 102 is configured to provide one or more cloud computing services and/or distributed computing services to users over the network 106. These services may include, but are not limited to, hosting applications, user authentication, file storage, system updates, and the like. Cloud infrastructure 102 includes one or more collections of servers 108, referred to as server farms, which are configured to provide computational and storage resources for services provided by the cloud infrastructure 102. Servers are implemented using any suitable number and type of physical and/or virtual computing resources (e.g., standalone computing devices, blade servers, virtual machines, etc.). In FIG. 1, two server farms 108 are shown although any suitable number of server farms can be utilized.

Cloud infrastructure 102 includes a cloud manager 110 for managing various aspects of the cloud infrastructure, such as deploying, configuring, and managing physical and/or virtual machines. Cloud manager 110 includes a load balancer 112 for distributing requests and workloads among server farms and/or among servers of a server farm. The load balancer 112 utilizes parameters such as load, number of connections, and server performance, to determine where to distribute the requests and workloads. Cloud manager 110 also includes a health monitoring system 114 configured to monitor the health of physical and virtual resources. and identify faulty components so that remedial action can be taken.

Client devices 104 enable users to access the services provided by the cloud infrastructure 102 via the network 106. Client devices 104 can be any suitable type of computing device, such as personal computers, desktop computers, laptop computers, smart phones, tablets, gaming consoles, smart televisions and the like. Client devices 104 include one or more client (software) applications 116 that are configured to interact with services made available by cloud infrastructure 102. In so embodiments, client applications 116 include dedicated applications installed on the client device and programmed to interact with one or more services provided by cloud infrastructure. In other embodiments, client applications 116 include general purpose applications, such as a web browser, configured to access services over the network 106.

In accordance with the disclosure, cloud manager 110 includes a fault injection system 118 that enables predetermined faults to be injected into selected components of the cloud infrastructure 102. The fault injection system 118 is configured to receive user input in the form of a fault definition which defines the parameters and attributes of a fault to be injected into the cloud infrastructure, such as fault type(s), fault scope, deployment policy, and the like. The fault definition is then used as the basis for instantiating a fault injection agent on targeted component(s) which is capable of causing the fault type(s) from the fault definition to occur in the targeted component(s).

In embodiments, the cloud manager 110 includes a telemetry component 120 that is configured to receive telemetry data from components of the cloud infrastructure 102 and/or client devices 104. The telemetry component 120 may be configured to analyze the telemetry data and/or user feedback to determine a performance level of components. Based on the performance level, fault deployment can be advanced to the next deployment stages or stopped completely.

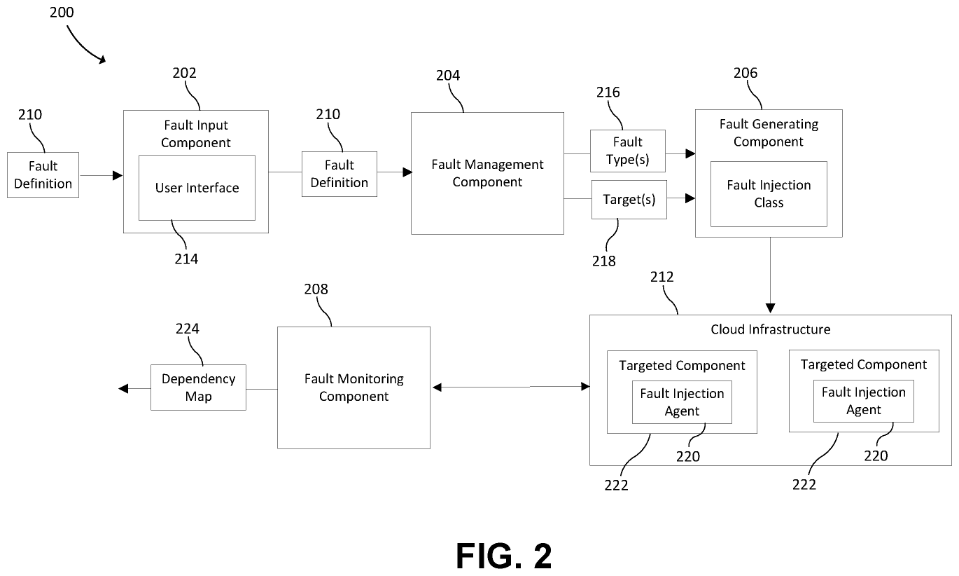

An example implementation of a fault injection system 200 is shown in FIG. 2. Fault injection system 200 includes a fault input component 202, a fault management component 204, a fault injection service 206, and a fault monitoring component 208. Fault input component 202 is configured to receive a fault definition 210 for faults to be injected into a cloud infrastructure 212. In embodiments, fault input component 202 includes a user interface 214 that is displayed on a display of a computing device and that enables a user to input the fault definition 210. In embodiments, the user interface 214 is a command line interface which enables parameters and attributes of a fault definition to be entered by typing the appropriate text into a text input field. In other embodiments, the user interface 214 is a graphical user interface including user interface controls, such as text entry fields, menus, buttons, and the like for inputting the parameters and attributes of a fault definition. In embodiments, the fault definition 210 is provided as an electronic file to the fault injection system 200, such as a JavaScript Object Notation (JSON), an Extensible Markup Language (XML) file, or the like, although any suitable file type and/or format may be utilized.

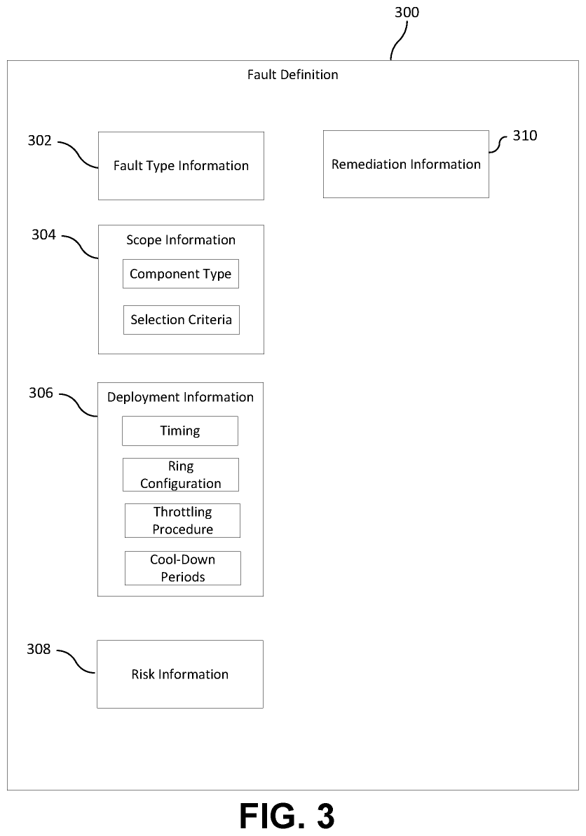

A diagram showing an example fault definition 300 is shown in FIG. 3. The fault definition of FIG. 3 includes fault type information 302, scope information 304, deployment information 306. Fault type information 302 identifies one or more faults to be injected. Examples of faults include physical memory pressure, virtual memory pressure, network latency, central processing unit (CPU) pressure, killing processes, disk speed faults, date faults, etc. In embodiments, faults that may be included in a fault definition are taken from a predefined fault list that has been generated for the cloud infrastructure. In embodiments, software implemented methods for injecting the faults into components of the cloud infrastructure have been created beforehand which can be called by fault injection agents to cause selected faults to be injected as needed.

Certain faults may present security concerns, such as data exposure, loss of data, risk of being hijacked, and the like. In embodiments, these critical faults can be prevented from being utilized in a fault definition. For example, an approved fault list may be generated for the fault injection system that includes only faults which have been approved for injection into the cloud infrastructure by appropriate authorities. Alternatively, a deny fault list can be generated that includes the critical faults. Received fault definitions can be checked against an approved fault list or a deny fault list to verify whether selected faults are allowed to be used. Alternatively, an approved fault list or a deny fault list can be used to limit available options that a user can select when entering a fault definition. In some embodiments, rather than preventing critical faults from being used by the system, the methods used to implement critical faults can be restricted in order to mitigate security concerns.

The scope information 304 defines a scope for the fault, such as the type and/or function of components that are being targeted. Examples of components include computing devices, virtual machines, software components and processes that perform various tasks for the cloud infrastructure, such as request processing, virtual machine monitoring, virtual machine allocating, health monitoring, etc. Scope information 304 can indicate other selection criteria, such as memory and/or CPU usage levels, past incidents, risk levels, service tiers (i.e., data driven selection), and the like. Scope information 304 can also designate other criteria to use for target selection, such as customer type (e.g., education, banking, airline, etc.), geographic range for the fault (e.g., city, state, country, zone, regional, global and the like).

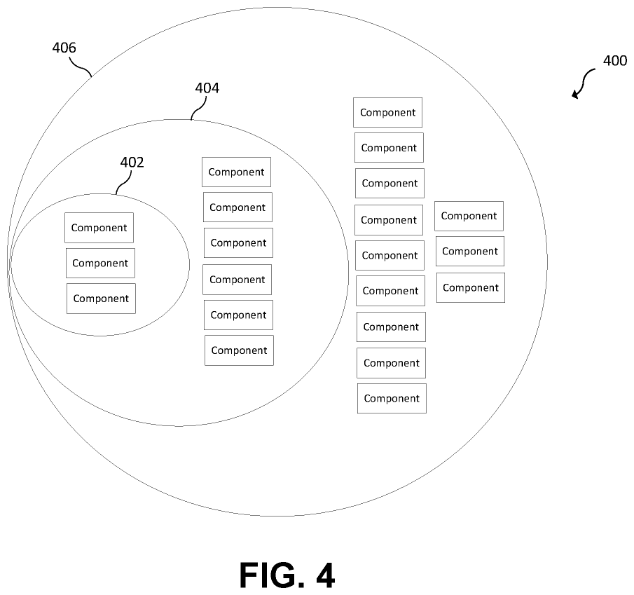

The deployment information 306 defines various parameters for deploying a fault, such as timing (e.g., start time, end time, peak hours or off-peak hours, etc.), deployment ring configuration, throttling procedure, and the like. Timing can be used to designate timing parameters, such as start time, end time, during peak hours or non-peak hours, and the like. A deployment ring configuration refers to the configuration of rings to use in deploying a fault. Each ring represents a different logical division of computing resources within a cloud infrastructure. For example, smaller, inner rings can represent developers and/or testers for a cloud infrastructure while larger, outer rings represent customer groups. An example deployment ring configuration 400 that may be designated by the deployment information for a fault is shown in FIG. 4. The ring configuration 400 includes three rings 402, 404, 406 which correspond to a first ring level 402, a second ring level 404 and a third ring level 406. The first ring level 402 is the smallest ring level includes the smallest number of components. The first ring level 402 is included in the second ring level 404. The second ring level 404 is the next smallest ring level and includes more components than the first ring level 402. The second ring level 404 is included in the third ring level 406. The third ring level 406 includes more components than the second ring level 404. A fault is first introduced into the components in the smallest ring level 402. Depending on the impact of the fault on the components in the first ring level 402, the fault is introduced into the components of the second ring level 404. Depending on the impact of the fault on the components in the second ring level 404, the fault is introduced into the components of the third ring level 406.

The throttling procedure for a fault refers to methods for throttling (i.e., slowing down) deployment of a fault within the scope of the fault and/or within one or more of the ring levels for the fault. For example, a deployment policy for a fault may indicate that the fault should be throttled by introducing the fault into a first portion (e.g., 1%) of components within the scope and/or current ring level, then into a second portion (e.g., 5%), then into a third portion (e.g., 10%), and so on until the fault has been introduced into all targeted components and/or all targeted components within a ring level. In embodiments, deployment information for a fault can also define the length of cool-down periods, or bake times, to be used during fault deployment. A bake-time refers to a period of time after a fault has been introduced into one ring level and/or throttling stage before the fault is introduced into the next level and/or stage.

The fault definition 300 may also include risk information 308 indicates risk level associated with the fault. For example, the risk information may indicate whether the fault is low, medium, or high risk. Other implementations may include a numerical rating or other indication that represents a risk level associated with the update. The risk level may be determined based on the potential impact of the fault on the customer base. A high-risk fault may be associated with features used by many users and may significantly impact the ability of these users to utilize the services provided by the cloud infrastructure. A medium-risk fault may impact fewer users than a high-risk update, may impact features that are used by fewer users, and/or may not as severely impact the ability of users to use the services provided by the cloud infrastructure. A low-risk fault may impact few users and/or impact features that are infrequently used or would not impact the ability of most users to use the services provided by the cloud infrastructure.

In embodiments, the fault definition also includes remediation information 310. Remediation information identifies the remediation plan for addressing the impact of a fault on the cloud infrastructure. For example, remediation information can identify the type of remediation plan, e.g., failover plan, backup solution, automatic rollback procedure, and the like, as well as parameters of the remediation plan.

Referring again to FIG. 2, once a fault definition 210 has been received by the fault input component 202, the fault definition 210 is provided to the fault management component 204 which orchestrates the injection of the fault to targeted components 222 in accordance with the fault definition 210. In embodiments, the fault management component 204 is configured to interact with the fault injection service 206 to cause the fault to be injected into the targeted components 222. The fault injection service 206 is a software application installed and registered in the operating system of components of the cloud infrastructure 212 The fault injection service is programmed to generate fault injection agents 222 which are executed on targeted components to cause selected faults in the targeted components. In embodiments, fault injection agents are instantiated based on a predefined fault injection class 226. The fault injection class 226 defines the functions, methods, variables, protocols, application programming interfaces (APIs), and the like which enable fault injection agents to be created and executed on a targeted component with designated features and functionality for causing selected faults in targeted components. Based on the fault definition, the fault management component 204 determines which components of the cloud infrastructure to target and to communicate and interact with the fault injection service 206 on targeted components to cause fault injection agents to be instantiated on the targeted components at desired times which have the capabilities needed to cause selected fault(s).

The fault injection system 200 includes a fault monitoring component 208 for monitoring the impact of fault on the cloud infrastructure 212. In embodiments, the fault monitoring component communicates with a telemetry component and/or a health monitoring component for the cloud infrastructure 212 to receive fault impact information pertaining to injected faults. Telemetry and/or health information can be used to determine the impact of faults on component performance. In embodiments, telemetry and/or health information is used as the basis for determining when to expand the deployment of a fault to the next ring.

The fault monitoring component 208 is also configured to monitor the impact of faults to determine whether the fault should be ended. For example, the fault monitoring component can be configured to monitor the impact of faults for one or more predetermined signals indicative of the faults having undesired consequences, such as significant unforeseen and/or critical outages. When the predetermined signals are detected, the fault management component is notified, and fault cancelation procedures are commenced. In embodiments, a fault is canceled by sending messages/commands to appropriate fault injection agents which causes the fault injection agents to stop injecting the fault and/or terminates the fault injection agent.

In embodiments, the fault monitoring component 208 is configured to compare previous performance levels of components (i.e., performance levels prior to the fault being introduced) to performance levels of the components while the fault is being injected into the cloud infrastructure to determine an impact of the fault on the components of the cloud infrastructure. This information is also used to determine a dependency map 224 for the cloud infrastructure 212. The dependency map identifies components and/or services that are impacted by the performance of other components and/or services. The dependency map can also indicate a degree to which components and/or services of the cloud infrastructure are dependent on the performance of other components and/or services. In embodiments, the magnitude of the impact of the fault on the components of the cloud infrastructure is used as the basis for determining the level of dependence of components on other components of the cloud infrastructure. In embodiments, different dependency maps can be generated for a cloud infrastructure which are based on different types of faults.

Once the direct impact as well as indirect impact of faults on the components of a cloud infrastructure have been identified, plans for remediating and mitigating faults can be generated, not only for the components directly impacted by the fault (i.e., the targeted components), but for the components indirectly impacted by the faults as well (i.e., dependent components).

A fault injection system can also be used to inject conditions into a cloud infrastructure to test remediation plans (e.g., failover, backup, rollback, etc.). While remediation plans can be made to help the cloud infrastructure deal with and recover from certain fault conditions, it is difficult to predict how effective remediation plans are during actual use of the cloud infrastructure. The fault injection system enables faults to be injected into the system in a controlled manner to cause remediation plans to be executed which in turn enables the effectiveness of remediation plans to be evaluated under real world conditions but without the real-world consequences.

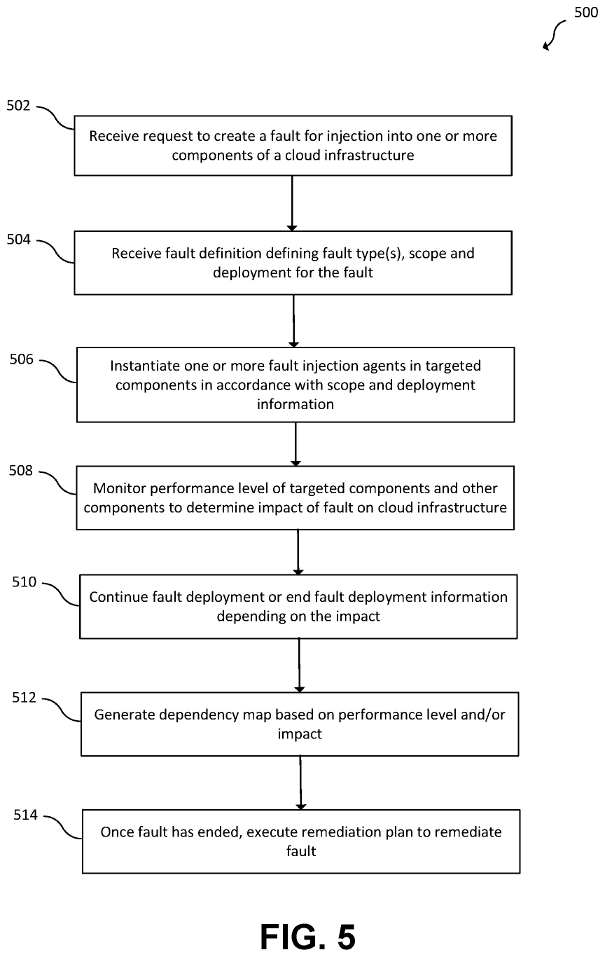

FIG. 5 is a flowchart of an example method 500 for creating and injecting faults in a cloud infrastructure. The method 500 begins with receiving a request to create a fault for injecting into one or more components of the cloud infrastructure (block 502). In addition, a fault definition is received which defines various attributes of the fault (block 504). The fault definition includes at least fault type information, scope information, and deployment information. One or more fault injection agents are then instantiated in targeted components in accordance with the scope and deployment information (block 506). The performance level of the targeted components and other components of the cloud infrastructure is monitored to determine the impact of the fault on the cloud infrastructure (block 508). Depending on the impact of the fault, fault deployment is continued until the fault is injected into all targeted components or ended (block 510). A dependency map is generated based on the performance level of components and/or impact of fault (block 512). Once the fault is ended, a remediation plan is executed to remediate the fault (block 514).

A fault injection system can also be used to inject conditions into a cloud infrastructure to test remediation plans (e.g., failover, backup, rollback, etc.). While remediation plans can be made to help the cloud infrastructure deal with and recover from certain fault conditions, it is difficult to predict how effective remediation plans are during actual use of the cloud infrastructure. The fault injection system enables faults to be injected into the system in a controlled manner to cause remediation plans to be executed which in turn enables the effectiveness of remediation plans to be evaluated under real world conditions but without the real-world consequences.

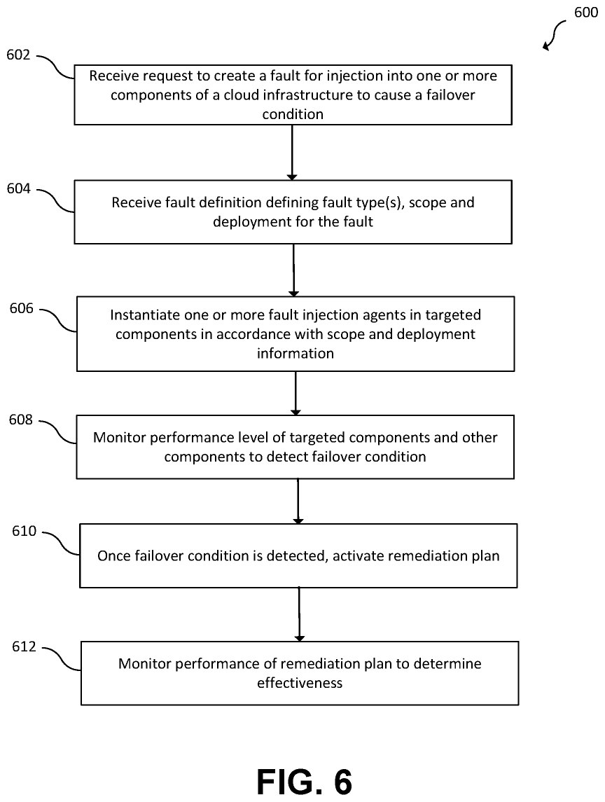

FIG. 6 shows an implementation of a method 600 for testing remediation plans for a cloud infrastructure. The method 600 begins with receiving a request to create a fault for injecting into one or more components of the cloud infrastructure to cause a failover condition in the cloud infrastructure (block 602). A fault definition is received which defines various attributes of the fault (block 604). The fault definition includes at least fault type information, scope information, and deployment information. One or more fault injection agents are then instantiated in targeted components in accordance with the scope and deployment information (block 606). The performance level of the targeted components and other components of the cloud infrastructure is monitored to detect the failover condition (block 608). Once the failover condition is detected, a remediation plan is activated for remediating the injected fault (block 610). The performance of the remediation plan is monitored to determine effectiveness (block 612).

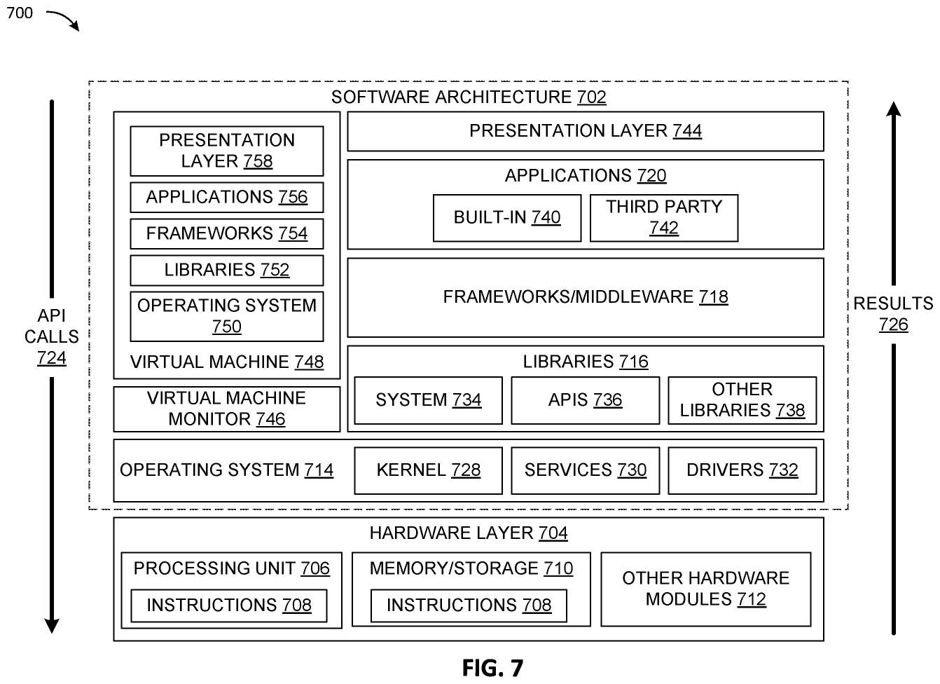

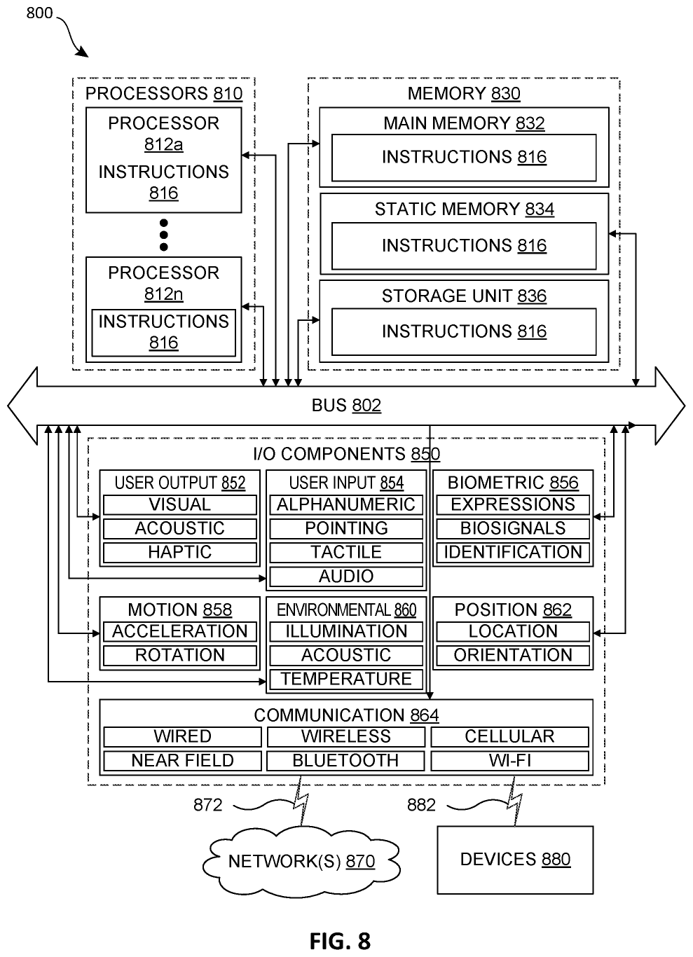

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, components of the cloud infrastructure 102 of FIG. 1. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per sc.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the following, further features, characteristics and advantages of the invention will be described by means of items:

Item 1. A fault injection system for a cloud infrastructure, the fault injection system comprising:

a processor; and

a memory in communication with the processor, the memory comprising executable instructions that, when executed by the processor alone or in combination with other processors, cause the fault injection system to perform functions of:

receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;

instantiating fault injection agents in the targeted components based on the scope information and the deployment information, the fault injection agents being configured to cause the at least one fault type in the targeted components;

monitoring a performance of the plurality of components while the fault injection agents are causing the at least one fault type in the targeted components to determine how the at least one fault type in the targeted components impacts the plurality of components; and

determining dependencies of components in the cloud infrastructure on other components of the cloud infrastructure based on the monitored performance of the plurality of components.

Item 2. The fault injection system of item 1, wherein the fault injection agents are instantiated from a fault injection class which is part of a fault injection service being executed in the components of the cloud infrastructure.
Item 3. The fault injection system of any of items 1-2, wherein the scope information defines a component type of the targeted components and selection criteria for selecting the targeted components from other components of a same type.
Item 4. The fault injection system of any of items 1-3, wherein the deployment information defines a deployment ring configuration for deploying the fault.
Item 5. The fault injection system of any of items 1-4, wherein the fault definition includes risk information pertaining to the targeted components.
Item 6. The fault injection system of any of items 1-5, further comprising:

determining a dependency map for the cloud infrastructure based on the monitored performance.

Item 7. The fault injection system of item 1, wherein the fault definition includes remediation information, the remediation information indicating a remediation plan for mitigating the fault, the remediation plan including at least one of a failover plan, a backup plan, and a rollback plan.
Item 8. A method for injecting fault into a cloud infrastructure, the method comprising:

receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;

instantiating fault injection agents in the targeted components based on the scope information and the deployment information, the fault injection agents being configured to cause the at least one fault type in the targeted components;

monitoring a performance of the plurality of components while the fault injection agents are causing the at least one fault type in the targeted components to determine how the at least one fault type in the targeted components impacts the plurality of components; and

determining dependencies of components in the cloud infrastructure on other components of the cloud infrastructure based on the monitored performance of the plurality of components.

Item 9. The method of item 8, wherein the fault injection agents are instantiated from a fault injection class which is part of a fault injection service being executed in the components of the cloud infrastructure.
Item 10. The method of any of items 8-9, wherein the scope information defines a component type of the targeted components and selection criteria for selecting the targeted components from other components of a same type.
Item 11. The method of any of items 8-10, wherein the deployment information defines a deployment ring configuration for deploying the fault.
Item 12. The method of any of items 8-11, wherein the fault definition includes risk information pertaining to the targeted components.
Item 13. The method of any of items 8-12, further comprising:

determining a dependency map for the cloud infrastructure based on the monitored performance.

Item 14. The method of any of items 8-13, wherein the fault definition includes remediation information, the remediation information indicating a remediation plan for mitigating the fault.
Item 15. A non-transitory computer readable medium on which are stored instructions that, when executed, cause a programmable device to perform functions of:

receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;

instantiating fault injection agents in the targeted components based on the scope information and the deployment information, the fault injection agents being configured to cause the at least one fault type in the targeted components;

monitoring a performance of the plurality of components while the fault injection agents are causing the at least one fault type in the targeted components to determine how the at least one fault type in the targeted components impacts the plurality of components; and

determining dependencies of components in the cloud infrastructure on other components of the cloud infrastructure based on the monitored performance of the plurality of components.

Item 16. The non-transitory computer readable medium of item 15, wherein the fault injection agents are instantiated from a fault injection class which is part of a fault injection service being executed in the components of the cloud infrastructure.
Item 17. The non-transitory computer readable medium of any of items 15-16, wherein the scope information defines a component type of the targeted components and selection criteria for selecting the targeted components from other components of a same type.
Item 18. The non-transitory computer readable medium of any of items 15-17, wherein the deployment information defines a deployment ring configuration for deploying the fault.
Item 19. The non-transitory computer readable medium of any of items 15-18, wherein the fault definition includes risk information pertaining to the targeted components.
Item 20. The non-transitory computer readable medium of any of items 15-19, further comprising:

determining a dependency map for the cloud infrastructure based on the monitored performance.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding. none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A fault injection system for a cloud infrastructure, the fault injection system comprising:
a processor; and
a memory in communication with the processor, the memory comprising executable instructions that, when executed by the processor alone or in combination with other processors, cause the fault injection system to perform functions of:
receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;
instantiating fault injection agents in the targeted components based on the scope information and the deployment information while the targeted components are performing tasks in support of the at least one service, the fault injection agents being configured to cause the at least one fault type in the targeted components;
monitoring a performance of the plurality of components while the fault injection agents are causing the at least one fault type in the targeted components to determine how the at least one fault type in the targeted components impacts the plurality of components; and
determining dependencies of components in the cloud infrastructure on other components of the cloud infrastructure based on the monitored performance of the plurality of components while the fault injection agents are causing the at least one fault type in the targeted components.

2. The fault injection system of claim 1, wherein the fault injection agents are instantiated from a fault injection class which is part of a fault injection service being executed in the components of the cloud infrastructure.

3. The fault injection system of claim 1, wherein the scope information defines a component type of the targeted components and selection criteria for selecting the targeted components from other components of a same type.

4. The fault injection system of claim 1, wherein the deployment information defines a deployment ring configuration for deploying the fault.

5. The fault injection system of claim 1, wherein the fault definition includes risk information pertaining to the targeted components.

6. The fault injection system of claim 1, further comprising:
determining a dependency map for the cloud infrastructure based on the monitored performance.

7. The fault injection system of claim 1, wherein the fault definition includes remediation information, the remediation information indicating a remediation plan for mitigating the fault, the remediation plan including at least one of a failover plan, a backup plan, and a rollback plan.

8. A method for injecting fault into a cloud infrastructure, the method comprising:
receiving a fault definition that defines at least one fault type to be injected into one or more targeted components of the cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;
instantiating fault injection agents in the targeted components based on the scope information and the deployment information while the targeted components are performing tasks in support of the at least one service, the fault injection agents being configured to cause the at least one fault type in the targeted components;
monitoring a performance of the plurality of components while the fault injection agents are causing the at least one fault type in the targeted components to determine how the at least one fault type in the targeted components impacts the plurality of components; and
determining dependencies of components in the cloud infrastructure on other components of the cloud infrastructure based on the monitored performance of the plurality of components while the fault injection agents are causing the at least one fault type in the targeted components.

9. The method of claim 8, wherein the fault injection agents are instantiated from a fault injection class which is part of a fault injection service being executed in the components of the cloud infrastructure.

10. The method of claim 8, wherein the scope information defines a component type of the targeted components and selection criteria for selecting the targeted components from other components of a same type.

11. The method of claim 8, wherein the deployment information defines a deployment ring configuration for deploying the fault.

12. The method of claim 8, wherein the fault definition includes risk information pertaining to the targeted components.

13. The method of claim 8, further comprising:
determining a dependency map for the cloud infrastructure based on the monitored performance.

14. The method of claim 8, wherein the fault definition includes remediation information, the remediation information indicating a remediation plan for mitigating the fault.

15. A non-transitory computer readable medium on which are stored instructions that, when executed, cause a programmable device to perform functions of:
receiving a fault definition that defines at least one fault type to be injected into one or more targeted components of a cloud infrastructure, the cloud infrastructure providing at least one service to clients and including a plurality of components that perform various tasks in support of the at least one service, the plurality of components including hardware and software components, the targeted components being selected from the plurality of components, the fault definition being an electronic file that identifies the at least one fault type intended to negatively impact performance of the one or more targeted components and including scope information and deployment information pertaining the fault, the scope information including selection criteria for indicating which of the plurality of components are the targeted components, the deployment information defining parameters for deploying the fault to the targeted components;
instantiating fault injection agents in the targeted components based on the scope information and the deployment information while the targeted components are performing tasks in support of the at least one service, the fault injection agents being configured to cause the at least one fault type in the targeted components;
monitoring a performance of the plurality of components while the fault injection agents are causing the at least one fault type in the targeted components to determine how the at least one fault type in the targeted components impacts the plurality of components; and
determining dependencies of components in the cloud infrastructure on other components of the cloud infrastructure based on the monitored performance of the plurality of components while the fault injection agents are causing the at least one fault type in the targeted components.

16. The non-transitory computer readable medium of claim 15, wherein the fault injection agents are instantiated from a fault injection class which is part of a fault injection service being executed in the components of the cloud infrastructure.

17. The non-transitory computer readable medium of claim 15, wherein the scope information defines a component type of the targeted components and selection criteria for selecting the targeted components from other components of a same type.

18. The non-transitory computer readable medium of claim 15, wherein the deployment information defines a deployment ring configuration for deploying the fault.

19. The non-transitory computer readable medium of claim 15, wherein the fault definition includes risk information pertaining to the targeted components.

20. The non-transitory computer readable medium of claim 15, further comprising:
determining a dependency map for the cloud infrastructure based on the monitored performance.
